(19) United States
(12) Patent Application Publication
(10) Pub. No.: US 2022/0056201 A1
(43) Pub. Date: Feb. 24, 2022

(54) METHOD FOR MANUFACTURING POLYESTER POLYHYDRIC ALCOHOL

(71) Applicant: NAN YA PLASTICS CORPORATION, Taipei (TW)

(72) Inventors: TE-CHAO LIAO, TAIPEI (TW); JUNG-JEN CHUANG, TAIPEI (TW); ZHANG-JIAN HUANG, TAIPEI (TW)

(21) Appl. No.: 17/338,843

(22) Filed: Jun. 4, 2021

(30) Foreign Application Priority Data
Aug. 20, 2020 (TW) 109128383

(51) Int. Cl. C08G 63/16; C08G 63/85

(52) U.S. Cl. CPC C08G 63/16; C08G 63/85

(57) ABSTRACT

A method for manufacturing polyester polyhydric alcohol is provided. The method for manufacturing polyester polyhydric alcohol includes steps as follows. A polybasic acid and a polyhydric alcohol are mixed for oligomerization to form an oligomer mixture. A catalyst is added into the oligomer mixture at a temperature ranging from 190° C. to 210° C. for polycondensation to obtain a polyester polyhydric alcohol product. The polyester polyhydric alcohol product has a number average molecular weight lower than 1000 g/mol and an acid value lower than or equal to 0.3 mg KOH/g.

### CROSS-REFERENCE TO RELATED PATENT APPLICATION

This application claims the benefit of priority to Taiwan Patent Application No. 109128383, filed on Aug. 20, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for manufacturing polyester polyhydric alcohol, and more particularly to a method for manufacturing polyester polyhydric alcohol having a low acid value.

### BACKGROUND OF THE DISCLOSURE

Polyester polyhydric alcohol has an excellent abrasion resistance, an excellent oil resistance, and a high mechanical strength, thereby usually being used as a main material to synthesize polyurethane. In some special applications, polyester polyhydric alcohol with low molecular weight (lower than 5000 g/mol) is used to synthesize polyurethane that has a soft texture.

However, a method for manufacturing polyester polyhydric alcohol in a conventional technology has some restrictions. For example, a molecular weight of polyester polyhydric alcohol usually ranges from 1000 g/mol to 5000 g/mol. The molecular weight of polyester polyhydric alcohol cannot be precisely controlled to be lower than 1000 g/mol; hence, applications of polyester polyhydric alcohol are restricted. In addition, polyester polyhydric alcohol that is prepared by using the conventional method has a high acid value (higher than 0.3 mg KOH/g), so that the polyester polyhydric alcohol cannot be applied in polyurethane products of high quality.

It is worth mentioning that the molecular weight of polyester polyhydric alcohol and the acid value of polyester polyhydric alcohol are not independent properties and are usually influenced by each other. Polyester polyhydric alcohol is formed from polybasic acid and polyhydric alcohol. Generally, the acid value of polyester polyhydric alcohol can be used as a criterion for monitoring an extent of reaction. When most of acid groups of the polybasic acid are reacted with hydroxyl group of the polyhydric alcohol for polycondensation and only a few amount of acid group are remained, the acid value of polyester polyhydric alcohol is low, that is, the extent of reaction is high. Therefore, when the extent of reaction is high, polyester polyhydric alcohol can have a long chain and a large molecular weight. In other words, the acid value of polyester polyhydric alcohol and the molecular weight of polyester polyhydric alcohol are approximately inversely proportional to each other.

Accordingly, there is still room for improvement in the conventional method for manufacturing polyester polyhydric alcohol in order to obtain polyester polyhydric alcohol that has both a low acid value and a low molecular weight.

### SUMMARY OF THE DISCLOSURE

In response to the above-referenced technical inadequacies, the present disclosure provides a method for manufacturing polyester polyhydric alcohol that has both a low acid value and a low molecular weight.

In one aspect, the present disclosure provides a method for manufacturing polyester polyhydric alcohol. The method for manufacturing polyester polyhydric alcohol includes steps as follows. A polybasic acid and a polyhydric alcohol are mixed for oligomerization to form an oligomer mixture. A catalyst is added into the oligomer mixture at a temperature ranging from 190° C. to 210° C. for polycondensation to obtain a polyester polyhydric alcohol product. The polyester polyhydric alcohol product has a number average molecular weight (Mn) lower than 1000 g/mol and an acid value lower than or equal to 0.3 mg KOH/g.

In certain embodiments, the oligomerization is carried out at a temperature ranging from 130° C. to lower than 190° C.

In certain embodiments, the oligomerization is carried out at a pressure ranging from 100 Torr to lower than or equal to 760 Torr.

In certain embodiments, the oligomerization continues to be carried out until an acid value of the oligomer mixture is lower than or equal to 1 mg KOH/g and then is stopped.

In certain embodiments, the polycondensation is carried out at a pressure ranging from 10 Torr to lower than or equal to 760 Torr.

In certain embodiments, the method further includes a step that the polyester polyhydric alcohol product is maintained at a pressure ranging from 200 Torr to lower than 760 Torr and a temperature ranging from 80° C. to 140° C.

In certain embodiments, the polybasic acid and the polyhydric alcohol are mixed in a reactor for oligomerization, a top of the reactor is fluidly communicated with a separation column, an unreacted part of the polyhydric alcohol is refluxed to the reactor through the separation column, and a by-product produced during the oligomerization is removed through the separation column.

In certain embodiments, a molar ratio of a hydroxyl group of the polyhydric alcohol to an acid group of the polybasic acid ranges from 1.1 to 1.5.

In certain embodiments, the polyester polyhydric alcohol product includes an aliphatic polyester polyhydric alcohol.

In certain embodiments, the polybasic acid is selected from the group consisting of: adipic acid, terephthalic acid, phthalic acid, isophthalic acid, sebacic acid, and any combination thereof.

In certain embodiments, the polyhydric alcohol is selected from the group consisting of: ethylene glycol, diethylene glycol, triethylene glycol, 1,3-propanediol, 2-methyl-1,3-propanediol, 1,4-butanediol, pentanediol, neopentyl glycol, 3-methyl-1,5-pentanediol, hexanediol, 1,4-cyclohexanedimethanol, glycerin, 1,1,1-trimethylolpropane, pentaerythritol, sorbitol, and combinations thereof.

In certain embodiments, the catalyst is an organic titanium catalyst or an organic tin catalyst.

Therefore, by virtue of “mixing a polybasic acid and a polyhydric alcohol for oligomerization to form an oligomer mixture” and “adding a catalyst into the oligomer mixture at a temperature ranging from 190° C. to 210° C. for polycondensation”, the method for manufacturing polyester polyhydric alcohol of the present disclosure can prepare the polyester polyhydric alcohol product that has the number average molecular weight lower than 1000 g/mol and the acid value lower than or equal to 0.3 mg KOH/g.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing polyester polyhydric alcohol of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A method for manufacturing polyester polyhydric alcohol of the present disclosure is provided. By two reaction stages and controlling temperatures of the two reaction stages, a polyester polyhydric alcohol product that has a number average molecular weight lower than 1000 g/mol and an acid value lower than or equal to 0.3 mg KOH/g can be obtained.

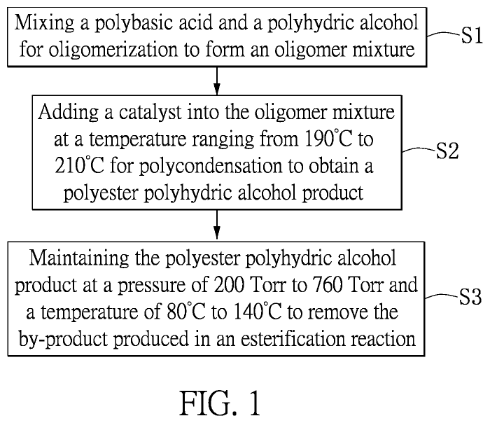

Referring to FIG. 1, FIG. 1 is a flowchart of the method for manufacturing polyester polyhydric alcohol of the present disclosure. In step S1, a polybasic acid and a polyhydric alcohol are mixed for oligomerization to form an oligomer mixture. The term “oligomerization” indicates that monomers are primarily polymerized to form a dimer, a trimer, or a tetramer.

In the present disclosure, a molar ratio of a hydroxyl group of the polyhydric alcohol to an acid group of the polybasic acid ranges from 1.1 to 1.5. The polybasic acid is a limiting reagent and the polyhydric alcohol is present in an excessive amount. Therefore, an extent of reaction in the oligomerization can be precisely monitored.

In the present disclosure, the polybasic acid is preferably diprotic acid. For example, the polybasic acid can be selected from the group consisting of: adipic acid, terephthalic acid, phthalic acid, isophthalic acid, sebacic acid, and any combination thereof. However, the present disclosure is not limited to that disclosed herein. In an exemplary embodiment, the polybasic acid is adipic acid.

In the present disclosure, the polyhydric alcohol can be selected from the group consisting of: ethylene glycol, diethylene glycol, triethylene glycol, 1,3-propanediol, 2-methyl-1,3-propanediol, 1,4-butanediol, pentanediol, neopentyl glycol, 3-methyl-1,5-pentanediol, hexanediol, 1,4-cyclohexanedimethanol, glycerin, 1,1,1-trimethylolpropane, pentaerythritol, sorbitol, and combinations thereof. However, the present disclosure is not limited to that disclosed herein. In an exemplary embodiment, the polyhydric alcohol is dibasic alcohol, such as 1,4-butanediol, ethylene glycol, or any combination thereof.

In an exemplary embodiment, the polybasic acid is an aliphatic acid, and the polyhydric alcohol is an aliphatic alcohol. Therefore, the polyester polyhydric alcohol is an aliphatic polyester polyhydric alcohol. A number average molecular weight of the polyester polyhydric alcohol is lower than 1000 g/mol and an acid value of the polyester polyhydric alcohol is lower than or equal to 0.3 mg KOH/g.

During the oligomerization (step S1), the polybasic acid and the polyhydric alcohol are mixed at a temperature ranging from 130° C. to lower than 190° C. for the oligomerization. In addition, the polybasic acid and the polyhydric alcohol can be mixed at either an atmospheric pressure or a vacuum environment for the oligomerization. In other words, the polybasic acid and the polyhydric alcohol can be mixed at a pressure ranging from 100 Torr to lower than or equal to 760 Torr for the oligomerization.

Specifically, the oligomerization is carried out in a reactor. A stirrer is installed in the reactor. A top of the reactor is fluidly communicated with a separation column. The separation column can enhance a separating effect between the polyhydric alcohol and a by-product. A condenser is installed on a top of the separation column and is fluidly communicated with the reactor. Therefore, a gas (e.g., polyhydric alcohol) separated by the separation column can be condensed and then refluxed to the reactor so as to reduce a usage of reactants.

The oligomerization is occurred when the polybasic acid and the polyhydric alcohol are reacted in the reactor, and a temperature of the reactor is set from 130° C. to lower than 190° C. Further, the reactor can be optionally vacuumed, so that the oligomerization can be carried out at a pressure ranging from 100 Torr to lower than or equal to 760 Torr. However, the present disclosure is not limited to that disclosed herein.

During the oligomerization, the by-product (i.e., water) is produced from an esterification reaction between the polybasic acid and the polyhydric alcohol in the reactor. The by-product (i.e., water) is removed through the separation column to prevent a hydrolysis reaction from negatively influencing the oligomerization. Further, the polyhydric alcohol, after being condensed, can be refluxed to the reactor through the separation column and react with the polybasic acid again for the oligomerization.

In an exemplary embodiment, the oligomerization continues to be carried out until the acid value of the oligomer mixture is lower than or equal to 1 mg KOH/g and then is stopped.

Referring to FIG. 1, in step S2, a catalyst is added into the oligomer mixture and the oligomer mixture is at a temperature ranging from 190° C. to 210° C. for polycondensation to obtain the polyester polyhydric alcohol product. The term “polycondensation” indicates that the dimer, the trimer, or the tetramer generated in step S1 are connected with each other via the acid group and the hydroxyl group at molecular ends thereof through an esterification reaction.

In the present disclosure, the catalyst can be an organic titanium catalyst or an organic tin catalyst, but is not limited thereto. Specifically, the organic titanium catalyst can be at least one of tetrabutyl titanium, tetramethyl titanate, tetraethyl titanate, tetrapropyl titanate, tetraisopropyl titanate, and tetrabutyl titanate. The organic tin catalyst can be at least one of tetrabutyltin, stannous octoate, di-n-butyltin oxide, and monobutyltin oxide. In an exemplary embodiment, the catalyst is tetrabutyl titanium, tetrabutyltin, or any combination thereof.

During the polycondensation (step S2), the oligomer mixture is reacted at a temperature ranging from 190° C. to 210° C. for the polycondensation. A product of the polycondensation contains the polyester polyhydric alcohol that has a low molecular weight and a low acid value. When the temperature of the polycondensation is too low (lower than 190° C.), the polycondensation is hard to proceed. On the other hand, when the temperature of the polycondensation is too high (higher than 210° C.), a reverse reaction is prone to occur, and the acid value of polyester polyhydric alcohol cannot be further decreased. Therefore, adjustment and control of temperature during the polycondensation is important. Specific experimental results regarding to the temperature during the polycondensation are illustrated as follows.

In addition, the polycondensation can be proceeded at a pressure of 10 Torr to lower than or equal to 760 Torr. Preferably, the polycondensation can be proceeded at a pressure of 10 Torr to lower than 760 Torr. More preferably, the polycondensation can be proceeded at a pressure of 10 Torr to lower than or equal to 50 Torr. However, the present disclosure is not limited to that disclosed herein.

In an exemplary embodiment, the polycondensation continues to be carried out until the acid value of the polyester polyhydric alcohol product is lower than or equal to 0.3 mg KOH/g and then is stopped.

Referring to FIG. 1, in step S3, the polyester polyhydric alcohol product is maintained at a pressure of 200 Torr to lower than or equal to 760 Torr and a temperature of 80° C. to 140° C. so as to remove the by-product (i.e., water) produced in the esterification reaction and to restrain the acid value of the polyester polyhydric alcohol product from increasing.

Specific experimental results are illustrated as follows to prove effects that can be generated by the method for manufacturing the polyester polyhydric alcohol of the present disclosure.

### Examples 1 to 4

In Examples 1 to 4, 700 g of adipic acid (polybasic acid) and 560 g of 1,4-butanediol (polyhydric alcohol) are put into a 2 L three-necked glass reactor, and are stirred and mixed in the 2 L three-necked glass reactor. The stirrer is installed in the reactor. The separation column is fluidly communicated with the top of the reactor.

A temperature of the reactor is controlled to range from 130° C. to lower than 190° C. and a pressure in the reactor is controlled to be 760 Torr so as to mix adipic acid and 1,4-butanediol for the oligomerization and to form the oligomer mixture. During the oligomerization, the by-product (i.e., water) produced by the esterification reaction and 1,4-butandiol (polyhydric alcohol) can be separated by the separation column. In order to prevent a hydrolysis reaction, the by-product (i.e., water) is separated from the separation column and then removed through the separation column. Further, in order to reduce the usage of reactants, 1,4-butandiol (polyhydric alcohol) separated from the separation column can be refluxed to the reactor.

During the oligomerization, samples are taken from the reactor to monitor the acid value of the oligomer mixture. The oligomerization is stopped when the acid value of the oligomer mixture is lower than or equal to 1 mg KOH/g.

Subsequently, 0.08 g of tetrabutyltin (catalyst) is put into the reactor, and the temperature of the reactor is set to range from 190° C. to 210° C. for the polycondensation, so as to form the polyester polyhydric alcohol product. The temperatures of the reactor during the polycondensation in each of Examples 1 to 4 are listed in Table 1.

Moreover, during the polycondensation, samples are taken from the reactor to monitor the number average molecular weight of the polyester polyhydric alcohol product. The polycondensation is stopped when the number average molecular weight of the polyester polyhydric alcohol product is lower than or equal to 1000 g/mol. Preferably, the polycondensation is stopped when the number average molecular weight of the polyester polyhydric alcohol product is lower than or equal to 750 g/mol.

After the polycondensation, the polyester polyhydric alcohol product is maintained at a pressure of 200 Torr to 760 Torr and a temperature of 80° C. to 140° C., so as to remove the by-product (i.e., water) produced by the esterification reaction and to restrain the acid value of the polyester polyhydric alcohol product from increasing. At this time, the number average molecular weight (Mn) and the acid value of the polyester polyhydric alcohol product in each of Examples 1 to 4 are measured and listed in Table 1.

### Examples 5 to 8

In Examples 5 to 8, 700 g of adipic acid (polybasic acid) and 560 g of 1,4-butanediol (polyhydric alcohol) are put into a 2 L three-necked glass reactor, and are stirred and mixed in the 2 L three-necked glass reactor. The stirrer is installed in the reactor. The separation column is fluidly communicated with the top of the reactor.

The temperature of the reactor is controlled to range from 130° C. to lower than 190° C. and a pressure in the reactor is controlled to be 760 Torr, so as to mix adipic acid and 1,4-butanediol for the oligomerization and to form the oligomer mixture. During the oligomerization, the by-product (i.e., water) produced by the esterification reaction and 1,4-butandiol (polyhydric alcohol) can be separated by the separation column. In order to prevent a hydrolysis reaction, the by-product (i.e., water) is separated from the separation column and then removed through the separation column. Further, in order to reduce the usage of reactants, 1,4-butandiol (polyhydric alcohol) separated from the separation column can be refluxed to the reactor.

During the oligomerization, samples are taken from the reactor to monitor the acid value of the oligomer mixture. The oligomerization is stopped when the acid value of the oligomer mixture is lower than or equal to 1 mg KOH/g.

Subsequently, 0.08 g of tetrabutyl titanium (catalyst) is put into the reactor, and the temperature of the reactor is set to range from 190° C. to 210° C. for the polycondensation, so as to form the polyester polyhydric alcohol product. The temperatures of the reactor during the polycondensation in each of Examples 5 to 8 are listed in Table 2.

Moreover, during the polycondensation, samples are taken from the reactor to monitor the number average molecular weight of the polyester polyhydric alcohol product. The polycondensation is stopped when the number average molecular weight of the polyester polyhydric alcohol product is lower than or equal to 1000 g/mol. Preferably, the polycondensation is stopped when the number average molecular weight of the polyester polyhydric alcohol product is lower than or equal to 750 g/mol.

After the polycondensation, the polyester polyhydric alcohol product is maintained at a pressure of 200 Torr to 760 Torr and a temperature of 80° C. to 140° C., so as to remove the by-product (i.e., water) produced from the esterification reaction and to restrain the acid value of the polyester polyhydric alcohol product from increasing. At this time, the number average molecular weight (Mn) and the acid value of the polyester polyhydric alcohol product in each of Examples 5 to 8 are measured and listed in Table 2.

### Comparative Examples 1 to 4

In Comparative Examples 1 to 4, 700 g of adipic acid (polybasic acid) and 560 g of 1,4-butanediol (polyhydric alcohol) are put into a 2 L three-necked glass reactor, and are stirred and mixed in the 2 L three-necked glass reactor. The stirrer is installed in the reactor. The separation column is fluidly communicated with the top of the reactor.

The temperature of the reactor is controlled to range from 130° C. to lower than 190° C. and a pressure in the reactor is controlled to be 760 Torr so as to mix adipic acid and 1,4-butanediol for the oligomerization and to form the oligomer mixture. During the oligomerization, the by-product (i.e., water) produced by the esterification reaction and 1,4-butandiol (polyhydric alcohol) can be separated by the separation column. In order to prevent a hydrolysis reaction, the by-product (i.e., water) is separated from the separation column and then removed through the separation column. Further, in order to save an amount of reactants that is used, 1,4-butandiol (polyhydric alcohol) separated from the separation column can be refluxed to the reactor.

During the oligomerization, samples are taken from the reactor to monitor the acid value of the oligomer mixture. The oligomerization is stopped when the acid value of the oligomer mixture is lower than or equal to 1 mg KOH/g.

Subsequently, 0.08 g of tetrabutyltin (catalyst) is put into the reactor, and the temperature of the reactor is set to be higher than 210° C. or lower than 190° C. for the polycondensation so as to form the polyester polyhydric alcohol product. The temperatures of the reactor during the polycondensation in each of Comparative Examples 1 to 4 are listed in Table 1.

Moreover, during the polycondensation, samples are taken from the reactor to monitor the number average molecular weight of the polyester polyhydric alcohol product. The polycondensation is stopped when the number average molecular weight of the polyester polyhydric alcohol product is lower than or equal to 1000 g/mol. Preferably, the polycondensation is stopped when the number average molecular weight of the polyester polyhydric alcohol product is lower than or equal to 750 g/mol.

After the polycondensation, the polyester polyhydric alcohol product is maintained at a pressure of 200 Torr to 760 Torr and a temperature of 80° C. to 140° C., so as to remove the by-product (i.e., water) produced by the esterification reaction and to restrain the acid value of the polyester polyhydric alcohol product from increasing. At this time, the number average molecular weight (Mn) and the acid value of the polyester polyhydric alcohol product in each of Comparative Examples 1 to 4 are measured and listed in Table 1.

### Comparative Examples 5 to 8

In Comparative Examples 5 to 8, 700 g of adipic acid (polybasic acid) and 560 g of 1,4-butanediol (polyhydric alcohol) are put into a 2 L three-necked glass reactor, and are stirred and mixed in the 2 L three-necked glass reactor. The stirrer is installed in the reactor. The separation column is fluidly communicated with the top of the reactor.

The temperature of the reactor is controlled to range from 130° C. to lower than 190° C. and a pressure in the reactor is controlled to be 760 Torr, so as to mix adipic acid and 1,4-butanediol for the oligomerization and to form the oligomer mixture. During the oligomerization, the by-product (i.e., water) produced by the esterification reaction and 1,4-butandiol (polyhydric alcohol) can be separated by the separation column. In order to prevent a hydrolysis reaction, the by-product (i.e., water) is separated from the separation column and then removed through the separation column. Further, in order to save the amount of reactants that is used, 1,4-butandiol (polyhydric alcohol) separated from the separation column can be refluxed to the reactor.

During the oligomerization, samples are taken from the reactor to monitor the acid value of the oligomer mixture. The oligomerization is stopped when the acid value of the oligomer mixture is lower than or equal to 1 mg KOH/g.

Subsequently, 0.08 g of tetrabutyl titanium (catalyst) is put into the reactor, and the temperature of the reactor is set to range from higher than 210° C. or lower than 190° C. for the polycondensation, so as to form the polyester polyhydric alcohol product. The temperature of the reactor during the polycondensation in each of Comparative Examples 5 to 8 is listed in Table 2.

Moreover, during the polycondensation, samples are taken from the reactor to monitor the number average molecular weight of the polyester polyhydric alcohol product. The polycondensation is stopped when the number average molecular weight of the polyester polyhydric alcohol product is lower than or equal to 1000 g/mol. Preferably, the polycondensation is stopped when the number average molecular weight of the polyester polyhydric alcohol product is lower than or equal to 750 g/mol.

After the polycondensation, the polyester polyhydric alcohol product is maintained at a pressure of 200 Torr to 760 Torr and a temperature of 80° C. to 140° C., so as to remove the by-product (i.e., water) produced from the esterification reaction and to restrain the acid value of the polyester polyhydric alcohol product from increasing. At this time, the number average molecular weight (Mn) and the acid value of the polyester polyhydric alcohol product in each of Comparative Examples 5 to 8 are measured and listed in Table 2.

TABLE 1

| | | Example | | | | Comparative Example | | | |
|---|---|---|---|---|---|---|---|---|---|
| | | 1 | 2 | 3 | 4 | 1 | 2 | 3 | 4 |
| Temperature of | | 190 | 197 | 203 | 210 | 170 | 185 | 215 | 230 |
| polycondensation | | | | | | | | | |
| (° C.) | | | | | | | | | |
| Polyester | Mn | 680 | 642 | 672 | 693 | 694 | 652 | 693 | 724 |
| polyhydric | (g/mol) | | | | | | | | |
| alcohol | Acid | 0.27 | 0.17 | 0.09 | 0.26 | 1.47 | 0.57 | 0.39 | 1.26 |
| | value | | | | | | | | |
| | (mg | | | | | | | | |
| | KOH/g) | | | | | | | | |

TABLE 2

| | | Example | | | | Comparative Example | | | |
|---|---|---|---|---|---|---|---|---|---|
| | | 5 | 6 | 7 | 8 | 5 | 6 | 7 | 8 |
| Temperature of | | 192 | 198 | 204 | 209 | 165 | 185 | 212 | 235 |
| polycondensation | | | | | | | | | |
| (° C.) | | | | | | | | | |
| Polyester | Mn | 650 | 631 | 684 | 677 | 574 | 627 | 675 | 707 |
| polyhydric | (g/mol) | | | | | | | | |
| alcohol | Acid | 0.28 | 0.19 | 0.11 | 0.28 | 2.04 | 0.59 | 0.32 | 0.48 |
| | value | | | | | | | | |
| | (mg | | | | | | | | |
| | KOH/g) | | | | | | | | |

According to Table 1 and Table 2, the method of the present disclosure can prepare the polyester polyhydric alcohol product that has the number average molecular weight lower than 1000 g/mol by having the two reaction stages (oligomerization and polycondensation). In addition, the method of the present disclosure can prepare the polyester polyhydric alcohol product that that has the acid value lower than or equal to 0.3 mg KOH/g by controlling the temperature of the polycondensation to be from 190° C. to 210° C. Therefore, the polyester polyhydric alcohol product prepared by using the method of the present disclosure can be applied to polyurethane products of high quality and soft texture.

According to Table 1 and Table 2, the number average molecular weight of the polyester polyhydric alcohol of the present disclosure ranges from 400 g/mol to 1000 g/mol. Preferably, the number average molecular weight of the polyester polyhydric alcohol of the present disclosure ranges from 400 g/mol to 800 g/mol. The acid value of the polyester polyhydric alcohol of the present disclosure ranges from 0.05 g KOH/g to 0.3 g KOH/g.

### BENEFICIAL EFFECTS OF THE EMBODIMENTS

In conclusion, by virtue of “mixing a polybasic acid and a polyhydric alcohol for oligomerization to form an oligomer mixture” and “adding a catalyst into the oligomer mixture at a temperature ranging from 190° C. to 210° C. for polycondensation”, the method for manufacturing polyester polyhydric alcohol of the present disclosure can prepare the polyester polyhydric alcohol product that has the number average molecular weight lower than 1000 g/mol and the acid value lower than or equal to 0.3 mg KOH/g.

Further, by virtue of “the oligomerization continuing to be carried out until an acid value of the oligomer mixture is lower than or equal to 1 mg KOH/g and then stopped”, the number average molecular weight of the polyester polyhydric alcohol product can be controlled.

Further, by virtue of “the polyester polyhydric alcohol product being maintained at a pressure ranging from 200 Torr to lower than 760 Torr and a temperature ranging from 80° C. to 140° C.”, the by-product produced by the esterification reaction can be removed and the increase of the acid value of the polyester polyhydric alcohol product can be restrained.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing polyester polyhydric alcohol, comprising:
mixing a polybasic acid and a polyhydric alcohol for oligomerization to form an oligomer mixture; and
adding a catalyst into the oligomer mixture at a temperature ranging from 190° C. to 210° C. for polycondensation to obtain a polyester polyhydric alcohol product;
wherein the polyester polyhydric alcohol product has a number average molecular weight lower than 1000 g/mol and an acid value lower than or equal to 0.3 mg KOH/g.

2. The method according to claim 1, wherein the oligomerization is carried out at a temperature ranging from 130° C. to lower than 190° C.

3. The method according to claim 2, wherein the oligomerization is carried out at a pressure ranging from 100 Torr to lower than or equal to 760 Torr.

4. The method according to claim 3, wherein the oligomerization continues to be carried out until an acid value of the oligomer mixture is lower than or equal to 1 mg KOH/g and is then stopped.

5. The method according to claim 1, wherein the polycondensation is carried out at a pressure ranging from 10 Torr to lower than or equal to 760 Torr.

6. The method according to claim 1, further comprising: the polyester polyhydric alcohol product being maintained at a pressure ranging from 200 Torr to lower than 760 Torr and a temperature ranging from 80° C. to 140° C.

7. The method according to claim 1, wherein the polybasic acid and the polyhydric alcohol are mixed in a reactor for oligomerization, a top of the reactor is fluidly communicated with a separation column, an unreacted part of the polyhydric alcohol is refluxed to the reactor through the separation column, and a by-product produced from the oligomerization is removed through the separation column.

8. The method according to claim 1, wherein a molar ratio of a hydroxyl group of the polyhydric alcohol to an acid group of the polybasic acid ranges from 1.1 to 1.5.

9. The method according to claim 1, wherein the polyester polyhydric alcohol product includes an aliphatic polyester polyhydric alcohol.

10. The method according to claim 1, wherein the polybasic acid is selected from the group consisting of: adipic acid, terephthalic acid, phthalic acid, isophthalic acid, sebacic acid, and any combination thereof.

11. The method according to claim 1, wherein the polyhydric alcohol is selected from the group consisting of: ethylene glycol, diethylene glycol, triethylene glycol, 1,3-propanediol, 2-methyl-1,3-propanediol, 1,4-butanediol, pentanediol, neopentyl glycol, 3-methyl-1,5-pentanediol, hexanediol, 1,4-cyclohexanedimethanol, glycerin, 1,1,1-trimethylolpropane, pentaerythritol, sorbitol, and combinations thereof.

12. The method according to claim 1, wherein the catalyst is an organic titanium catalyst or an organic tin catalyst.
